(19) United States
(12) Patent Application Publication
(10) Pub. No.: US 2005/0076433 A1
(43) Pub. Date: Apr. 14, 2005

(54) Steam footbath

(76) Inventor: Anthony Kit Lun Leung, North Point (HK)

Correspondence Address: STEVEN A. GARNER;CONAIR CORPORATION, ONE CUMMINGS POINT ROAD, STAMFORD, CT, 06902, US

(21) Appl. No.: 10/964,364

(22) Filed: Oct. 13, 2004

Related U.S. Application Data
(60) Provisional application No. 60/510,973, filed on Oct. 14, 2003.

(51) Int. Cl. A47K 3/022; E03C 1/00; A61H 35/00

(52) U.S. Cl. 4/622

(57) ABSTRACT

A steam foot bath device that includes a steam output vent, a steam basin, a water reservoir to be heated to produce steam, a boiler for producing steam, and multiple control devices including a remote control as well as a control panel on the body of the device. Alternate embodiments of the present invention include a detachable remote control that serves as a body control panel when selectively affixed to the body.

### CROSS-REFERENCE TO RELATED APPLICATIONS

This application claims priority to U.S. Provisional Patent Application Ser. No. 60/510,973 filed on Oct. 14, 2003, incorporated herein by reference in its entirety.

### BACKGROUND OF THE INVENTION

1. Field of the Invention

The present invention relates to footbath devices for therapy or comfort and, more particularly, to steam footbath devices.

2. Description of Related Art

It is known in the art to provide various types of footbaths and foot spa therapy devices. Typical footbaths utilize water that is heated, so that a user's feet may be submerged into the heated water. At least one known device utilizes steam that can be released into a footbath basin that is similar in construction to a water-type footbath. Such a device lacks convenient and versatile controls in order to vary functions among optional modes.

### OBJECT AND SUMMARY OF THE INVENTION

It is an object of the present invention to overcome the shortcomings of the prior art mentioned above. These and other objects are achieved by the present invention described herein.

The present invention is directed to a steam footbath device that includes a steam output vent, a steam basin, a water reservoir to be heated to produce steam, a boiler for producing steam, and multiple control devices including a remote control as well as a control panel on the body of the device. Alternative embodiments of the present invention include a detachable remote control that serves as a body control panel when selectively affixed to the device body.

### BRIEF DESCRIPTION OF THE DRAWINGS

FIG. 1 is a front perspective view of a device according to a preferred embodiment of the present invention.

FIG. 2 is a front perspective view of a device according to a preferred embodiment of the present invention showing an open lid mode.

FIG. 3 is a top view of a component of the present invention.

FIG. 4 is a schematic of a component of the present invention.

### DETAILED DESCRIPTION OF THE INVENTION

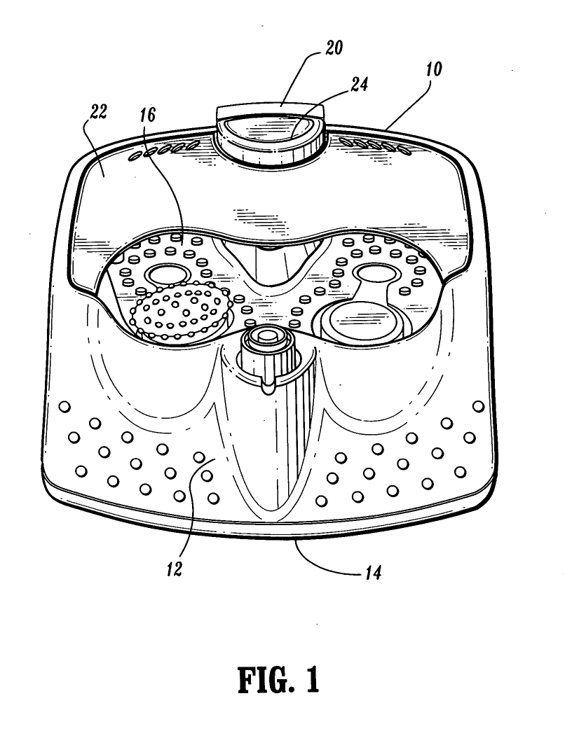

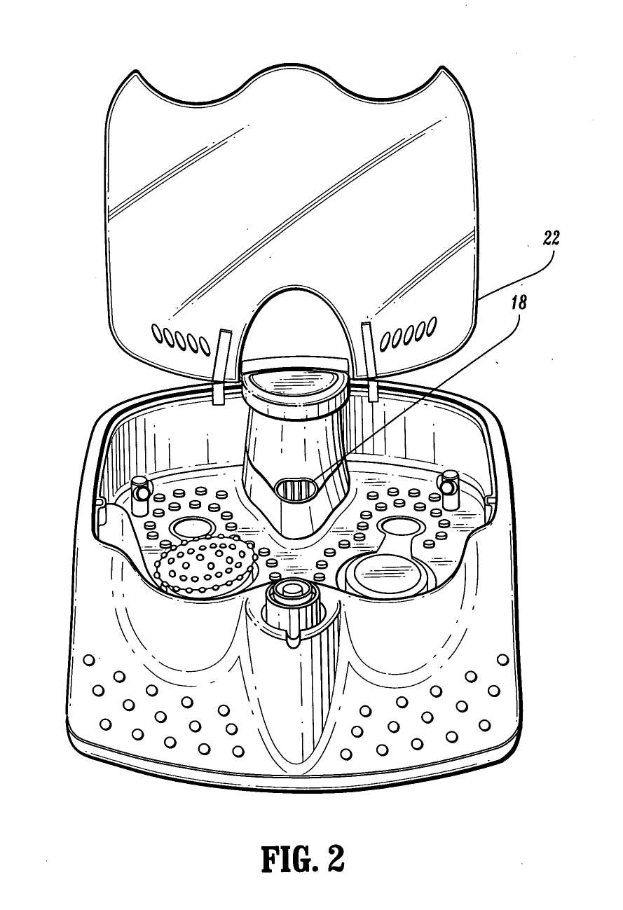

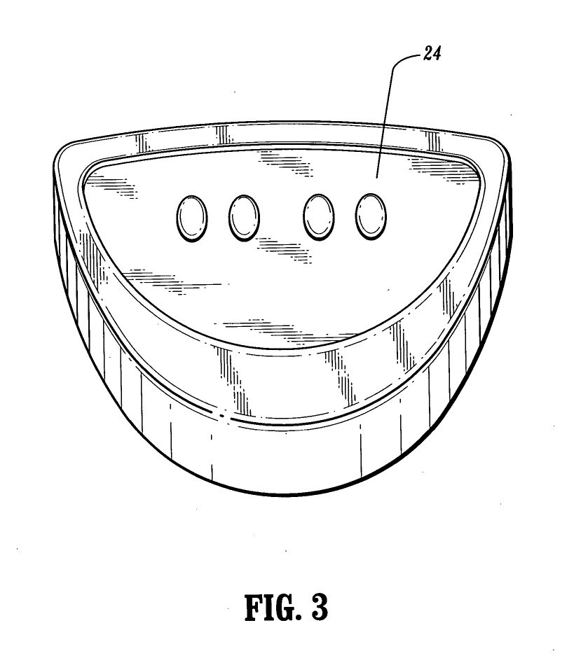

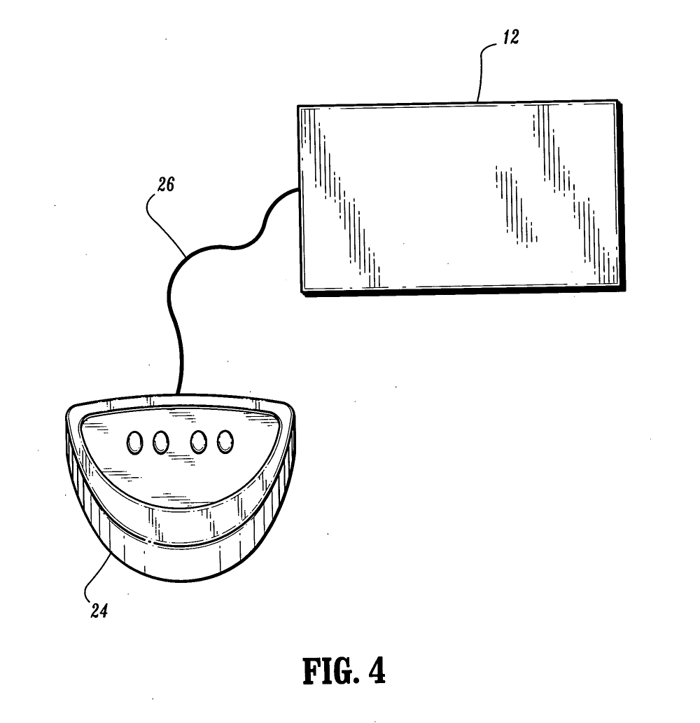

A preferred embodiment of the present invention steam foot bath (10) is shown in FIG. 1. The bath (10) comprises a body (12) that has a base (14) and a basin (16) formed therein. A steam vent (18) is provided in the basin (16) to emit steam into the basin (16). The steam is generated by first filling a removable water tank (20) with water and replacing into the body (12) as shown. The water from the tank (20) travels through valves and conduits (not shown) of the type generally known into a boiler or heater tank (not shown) housed in the body. The water is heated into vapor and expelled from the vent (18). The vapor may be powered by an internal fan (not shown) housed in the body (12) or it may flow out of the vent (18) under its own pressure. More than one vent may be implemented in the basin (16). The vent (18) may or may not be provided with flow control mechanisms including partially closeable louvers and/or louvers that may be aimed to direct the vapor flow. A lid (22) that is moveable between an opened position as shown in FIG. 2 and a closed position as shown in FIG. 1 is provided. A control unit (24) is provided having buttons that are connected to an electronic control circuit of the type generally known. Various functions are controlled by the unit (24). The unit (24), in a preferred embodiment, is mounted as shown in FIGS. 1 and 2 to be a body control panel, and is removable as shown in FIG. 3 to be used as a wireless remote control. Alternatively, as shown in FIG. 4, the control (24) may be tethered by a cord (26) to the body (12).

In operation, the user fills the tank (20) with water and positions the user's feet into the basin (16). The lid (22) is closed. The “steam” mode is activated by pushing the corresponding button on the controller (24). As the water is heated by the boiler, steam is emitted from the vent (18).

The bath (10) may include additional components such as a series of massage devices, water jets, and bubble jets as shown in the Figures and being of the type generally known. Thus, for example, the user may fill the basin (16) with water. The water will be heated and circulated by known means such that the device (10) can operate as a liquid foot bath with selectively actuable bubbles and/or water jets, as well as vibrational modes.

Thus, the device (10) may be a dedicated steam foot bath as described above, or it may be a combination steam foot bath and water foot bath. The device (10) may also be used for other functions where heat is applied to objects placed within the basin including, but not limited to, heated stone therapy where heated stones are placed in the basis to be heated and then removed for stone application to a user's body. The control panel (24), which may be removably attached to the body (12), may be adapted for toe control by having large buttons. The lid (22) may be double-hinged for compound folding. An additional alternative includes implementing a programmable timer circuit to time-out the steam function or other functions after a predetermined period of time.

While a preferred embodiment of the invention has been herein disclosed and described, it is understood that various modifications can be made without departing from the scope of the invention.

1. A footbath comprising:
a housing having a base;
a basin within said housing;
a vent in said basin for emitting steam; and
a control unit adapted to selectively emit steam.

2. A footbath according to claim 1, further comprising
a removable water tank within said housing for holding water to be heated into steam.

3. A footbath according to claim 2, further comprising
a boiler within said housing for heating said water in said water tank.

4. A footbath according to claim 1, further comprising
a lid on said housing.

5. A footbath according to claim 5, wherein
said lid is adapted to be movable between an opened position and a closed position.

6. A footbath according to claim 1, wherein
said control unit is a wireless remote control.

7. A footbath according to claim 7, wherein
said control unit is detachably mounted on said housing.

8. A footbath according to claim 1, wherein
said control unit is tethered by a cord to said housing.

9. A footbath according to claim 1, further comprising
a flow control mechanism for directing the flow of said steam.

10. A footbath according to claim 9, wherein
said flow control mechanism is an adjustable louver.
